(19) United States
(12) Patent Application Publication
(10) Pub. No.: US 2007/0130547 A1
(43) Pub. Date: Jun. 7, 2007

(54) METHOD AND SYSTEM FOR TOUCHLESS USER INTERFACE CONTROL

(75) Inventor: MARC BOILLOT, Plantation, FL (US)

Correspondence Address: MARC BOILLOT, 9110 NW 11TH COURT, PLANTATION, FL, 33322, US

(73) Assignee: NAVISENSE, LLC, Plantation, FL (US)

(21) Appl. No.: 11/566,137

(22) Filed: Dec. 1, 2006

Related U.S. Application Data
(60) Provisional application No. 60/741,358, filed on Dec. 1, 2005.

(51) Int. Cl. G06F 3/00

(52) U.S. Cl. 715/863

(57) ABSTRACT

A sensing unit (110) and method (200) for touchless interfacing using finger signing is provided. The sensing unit can include a sensor element (113) for tracking a touchless finger sign, a pattern recognition engine (114) for tracing a pattern in the touchless finger sign, and a processor (115) for performing an action on an object in accordance with the at least one pattern. The object may be a cursor, an object handled by the cursor, or an application object. A finger sign can be an touchless finger movement for controlling an object, or a touchless writing of an alpha-numeric character that is entered in an object. The processor can visually or audibly present the pattern in response to a recognition of the finger sign.

### CROSS-REFERENCE TO RELATED APPLICATIONS

This application claims the priority benefit of U.S. Provisional Patent Application No. 60/741,358 entitled “Method and System for Controlling an Object Using Sign Language” filed Dec. 1, 2005, the entire contents of which are hereby incorporated by reference. This application also incorporates by reference the following Utility Applications: U.S. patent application Ser. No. 11/559,295, Attorney Docket No. B00.02 entitled “Method and System for Directing a Control Action”, filed on Nov. 13, 2006, U.S. patent application Ser. No. 11/562,404, Attorney Docket No. B00.04 entitled “Method and System for Object Control”, filed on Nov. 21, 2006, U.S. patent application Ser. No. 11/562,410, Attorney Docket No. B00.06 entitled “Method and System for Range Measurement”, filed on Nov. 21, 2006, U.S. patent application Ser. No. 11/562,413, Attorney Docket No. B00.07 entitled “Method and System for Providing Sensory Feedback for Touchless Control”, filed on Nov. 21, 2006, Attorney Docket No. B00.09 entitled “Method and System for Mapping Virtual Coordinates” filed on Dec. 1, 2006, and Attorney Docket No. B00.10 entitled “Method and System for Activating a Touchless Control” filed on Dec. 1, 2006.

### BACKGROUND

1. Field

The present embodiments of the invention generally relate to the field of user interface systems, and more particularly to virtual user interfaces.

2. Background of the Invention

Motion detectors can detect movement. Motion detection systems can include radar systems, video camera monitoring systems, outdoor lighting systems, and medical diagnostic systems. Motion detection systems generally include a sensor which converts a physical signal into an electronic signal. The sensor performs the task of capturing the signal and converting it to a suitable format for processing. A motion detection system can include a processor for interpreting the sensory information and identifying whether an object has moved.

A computer system generally includes a mouse or touchpad to navigate and control a cursor on a computer display. A cursor on the screen moves in accordance with the physical motion of the mouse. A touchpad or stick can also be used to control the cursor on the display. The mouse, touchpad, and stick generally require physical movement to assume control of the cursor.

### SUMMARY

Embodiments of the invention concern a system and method for touchless control of an object using finger signing. In one embodiment, a sign engine for controlling an object, via touchless finger movements, is provided. The sign engine can include a touchless sensing unit having at least one sensing element for capturing a finger sign, a pattern recognition engine for identifying a pattern in the finger sign, and a processor for performing at least one action on an object, the action associated with the pattern. The touchless sensing unit can detect a touchless finger sign such a finger click action, or recognize a finger pattern in the touchless finger sign such as a letter or number. The pattern recognition engine can identify at least one pattern associated with the finger sign and perform an action in response to the identified sign. The sign engine can include a voice recognition unit that captures a spoken utterance from a user and determines whether the finger sign was correctly recognized in response to the spoken utterance. In one aspect the pattern recognition engine can recognize and authenticate a touchless finger signature for a secure application. The touchless finger signature may be a password to gain secure entry. In one arrangement, the pattern recognition engine can automatically complete a finger sign that is partially recognized. In another arrangement, a finger sign can provide a zooming operation to expand or compress a viewing of data.

One embodiment of the invention is a method for touchless interfacing using finger signing. The method can include detecting a touchless finger movement in a touchless sensing space, identifying a finger sign from the touchless finger movement, and performing a control action on an object in accordance with the finger sign. The step of identifying a finger sign can include recognizing an alpha-numeric character. The step of performing a control action can include entering the alpha-numeric character in an application. The alpha-numeric character can be entered in a text entry object, such as a text message or a phone dialing application. The step of performing a control action can also include issuing a single click, a double click, a scroll, a left click, a middle click, a right click, or a hold of the object in response to the finger sign. The step of performing a control action on an object can include adjusting a value of the object, selecting the object, moving the object, or releasing the object. The object can be an audio control, a video control, a voice control, a media control, or a text control. The step of performing a control action can also include performing a hot-key combination in response to recognizing a finger sign.

A finger sign can be a letter, a number, a circular pattern, a jitter motion, a sweep motion, a jitter motion, a forward projecting motion, a retracting motion, an accelerated sweep, or a constant velocity motion. In one aspect, performing a control action can complete a web based transaction, an email transaction, an internet transaction, an on-line purchase order, a sale, a notarization, or an acknowledgement. A control action can include a cut-and-paste operation, a text highlight operation, a drag-and-drop operation, a shortcut operation, a file open operation, a file close operation, a toolbar operation, a palette selection, a paint operation, a custom key shortcut operation, or a menu selection operation corresponding to a menu entry item in a windows application program.

One embodiment is directed to a method for touchless text entry via finger signing. The method can include tracking a touchless finger movement in a touchless sensing space, tracing out a pattern in accordance with the tracking, and recognizing an alpha-numeric character from the pattern. The pattern can be a letter, a number, a symbol, or a word. The method can further include presenting the alphanumeric character to a text messaging application or a phone dialing application. The method can include recognizing a finger signature and authenticating the finger signature. In one aspect, the finger signature can be a password that identifies a user. The method can further include recognizing when a user is having difficulty finger signing, and presenting visual notations of finger signs for conveying finger sign examples to the user.

Embodiments of the invention also concern a method for controlling an object. The method can include sensing a controlled movement for detecting a finger sign, identifying at least one pattern associated with the finger sign, and performing at least one action on an object, the action associated with the pattern. The action can correspond to controlling a cursor object on a computer using at least one finger. The action can activate a mouse behavior. As an example, a user can sign to a computer using a sign language to control a cursor object on the computer, sign an electronic form, enter a letter or number into an application, control a media object, or dial a number. The sign language can represent a vocabulary of signs or user interface commands. The step of identifying can further include recognizing when a user is having difficulty signing, and presenting visual notations of signs for conveying finger sign examples to said user.

### BRIEF DESCRIPTION OF THE DRAWINGS

The features of the present embodiments of the invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a touchless user interface system for finger signing in accordance with an embodiment of the inventive arrangements;

FIG. 2 is a sensing unit for processing touchless finger signs in accordance with an embodiment of the inventive arrangements; and

FIG. 3 is a touchless keyboard for finger signing in accordance with an embodiment of the inventive arrangements;

FIG. 4 is a touchless laptop for finger signing in accordance with an embodiment of the inventive arrangements;

FIG. 5 is a method for touchless interfacing using finger signing in accordance with an embodiment of the inventive arrangements;

FIG. 6 is a method for recognizing a finger sign in accordance with an embodiment of the inventive arrangements;

FIG. 7 is an exemplary set of finger signs in accordance with an embodiment of the inventive arrangements;

FIG. 8 is a touchless mobile device for finger signing in accordance with an embodiment of the inventive arrangements;

FIG. 9 is a side view of a touchless sensing space for finger signing in accordance with an embodiment of the inventive arrangements;

FIG. 10 is an exemplary set of finger signing applications in accordance with an embodiment of the inventive arrangements; and

FIG. 11 is a touchless headset for finger signing in accordance with an embodiment of the inventive arrangements

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a midlet, a source code, an object code, a shared library/dynamic load library and/or other sequence of instructions designed for execution on a computer system.

The term touchless sensing is defined as sensing movement without physically touching the object causing the movement. The term mounted is defined as a being attached to, connected to, part of, integrated within, associated with, coupled to, adjacent to, or near. The term sign is defined as being a controlled movement or physical gesture, such as a finger movement or hand movement for invoking a predetermined action. The term finger sign is the movement of an appendage, such as a hand or finger, for intentionally conveying a thought, command, or action particularly associated with the finger sign. The term cursor is defined as a cursor on a display. For example, a cursor position describes a location for point of insertion such as text, data, or action. The term cursor object is defined as an object that can receive coordinate information for positioning of the object. In one example, a cursor object can be the target of a game control (e.g. joystick) for handling an object in the game.

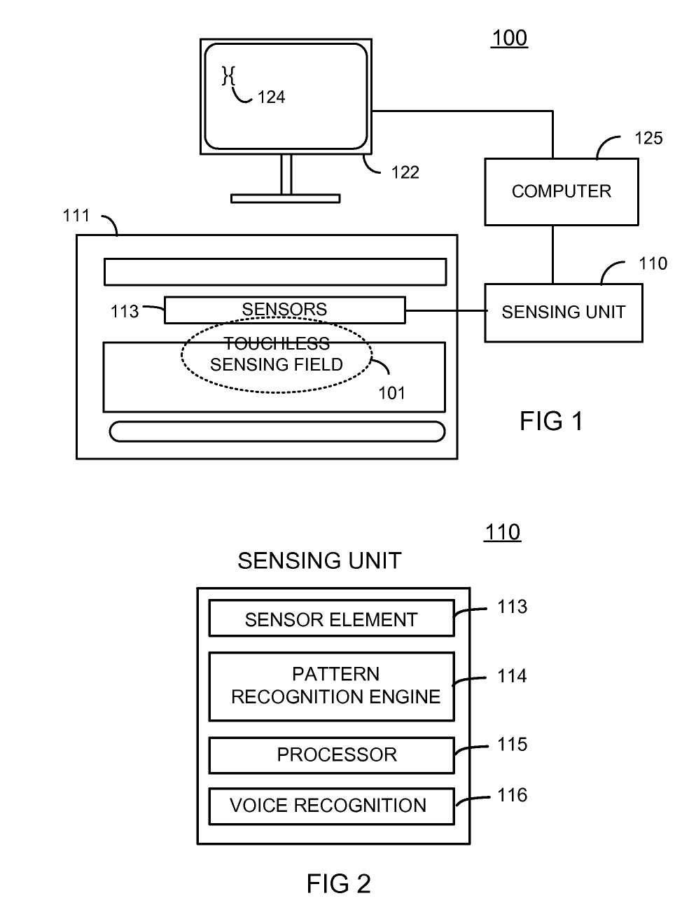

Referring to FIG. 1 a touchless user interface system 100 is shown. The touchless user interface system 100 can include a keyboard 111, a computer 125, a display 122, and a sensing unit 110. The sensing unit 110 can be operatively coupled to the keyboard 111 and communicatively coupled to the computer 125. The sensing unit 110 can include an array of sensors 113 that detects finger motion above the keyboard 111. In one arrangement, the array of sensors 113 can be in the same plane. In another arrangement, the array of sensors 113 can be distributed across a surface. Briefly, the sensing unit 110 can create a touchless sensing space 101 above the keyboard 111. The hands or fingers do not have to be in contact with the array of sensors 113, nor do they have to be directly over the array of sensors 113, called a sensor element 113. The sensing unit 110 detects finger movement above the keyboard 111 without the user having to manually control an input pointing device such as a mouse, a stick, a touchpad; or, having a physical apparatus connected to the user.

The sensing unit 110 can detect touchless finger movements above the keyboard 111 in the touchless sensing space 101 when the hands are positioned in the general typing position. For example, a user can move and control the cursor 124 on the display 122 in accordance with touchless finger movements. As an example, a user can issue a finger sign, such as a touchless downward button press, to perform a single click action on an object handled by the cursor 124. As another example, a user can write an alpha-numeric character, such as letter or number, in the touchless sensing space 108. The sensing unit 110 can recognize the letter or number and enter it into an application, such as a text message or a phone dialing application. In another arrangement, the sensing unit 110 can recognize and authenticate a finger signature for a secure application. The sensing unit 110 can also automatically complete a finger sign that is partially recognized. Notably, the finger sign is performed touchlessly without physical touching of a keyboard, keypad, stick, or mouse. The keyboard 111 can be a computer keyboard, a mobile device keypad, a personal digital assistant keypad, a game control keypad, or a communication device keypad, but is not limited to these.

Referring to FIG. 2, the sensing unit 110 can include the sensor element 113, a pattern recognition engine 114 operatively coupled to the sensor element 113 to recognize finger movements and finger signs in the touchless sensing space 101, and a processor 115 operatively coupled to the pattern recognition engine 114 and the sensor element 113 for performing an action in response to a finger sign. Briefly, the processor 115 can track a touchless finger movement in the touchless sensory space 108 and create a trace. The trace can contain salient features of the finger sign. The processor 115 can present the trace to the pattern recognition unit 114 for recognizing a pattern in the finger sign. The pattern recognition engine can identify a pattern of the finger sign from the trace. The processor 115 can present the recognized pattern to the display 122 to visually display the pattern. This allows a user to see the finger sign, or a recognized pattern associated with the finger sign. For example, if the user signs the letter “a”, the processor 115 can display a standard format character “a”. This is preferable to presenting the pattern, which may be a raw outline of the finger sign. As another example, if the user enters the sign for an “enter” command, the processor 115 can identify the selection that will be entered.

In another arrangement, the processor 115 can audibly present the recognized pattern. For example, the processor 115 can include an audio module (not shown) for verbally stating the recognized pattern. This allows a user to hear the recognized pattern. For example, the audio module can say “a” if the user signs the letter “a”. The sensing unit 110 can also include a voice recognition engine 116 to capture spoken utterances from the user. For example, the user, after seeing or hearing the recognized pattern, may say “no” to indicate that the recognized pattern is incorrect. The pattern recognition engine 114 can present another recognized pattern in response to an incorrect recognition. The voice recognition engine 116 can be communicatively coupled to the processor 115 and the pattern recognition engine 114 for receiving the recognized pattern. In one embodiment, the pattern recognition engine 114 can also serve as the voice recognition engine 116. The sensing unit 110 can be implemented in a computer, a laptop, a mobile device, a portable music player, an integrated electronic circuit, a gaming system, a multimedia system, a mobile communication device, or any other suitable communication device.

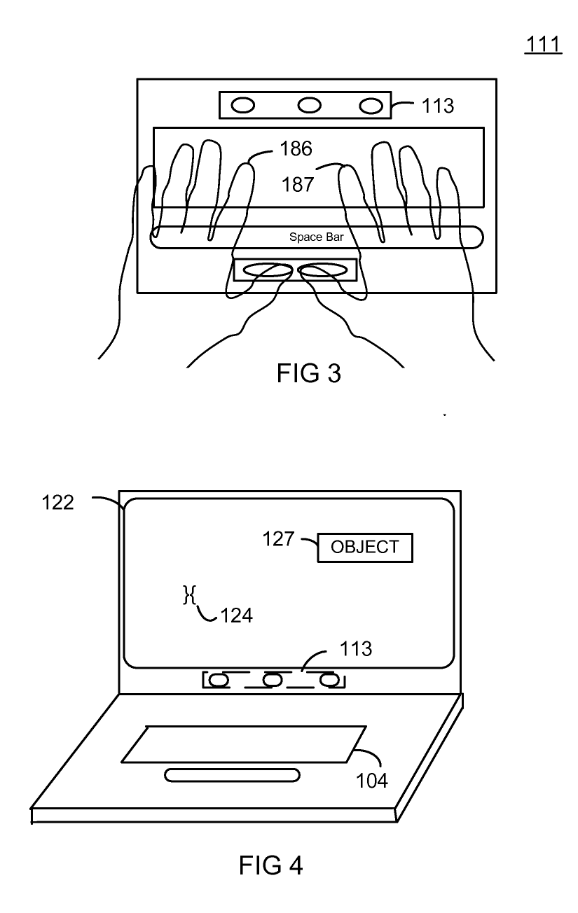

Referring to FIG. 3, one example use for finger signing is shown. A user can position two hands above the keyboard 111 for controlling a cursor object 124 within a display 122. A first finger 186 on the left hand and a second finger 188 on the right hand can control a cursor object 124 within the display 122. A user can move the first and second finger for signing motion to the computer to control the cursor object 124. For example, a user can control the cursor 124 to interact with a computer application for performing tasks such as text editing, web browsing, checking email, messaging, code programming, playing a game, or the like. The user can control the cursor within a text processing application, such as to identify where text can be entered and displayed (e.g. cut and paste). In another example, the user can control an object displayed within a program application. The object can be local to the program application or can be an object outside of the program application. In another arrangement, the user can control a media component such as an audio control or a video control. For example, the user can position the cursor 124 over an audio control, and adjust a volume using a touchless finger sign. As an example, the user may select songs in a song list by performing a touchless “check”. The user can position a cursor over a song in a list, and issue a “check” finger sign. The song can be selected for play in response to the finger sign. The user can also perform an “x” to cross out a selection. The song can be de-selected in response to the finger sign “x”.

In one arrangement, a first finger can control coarse navigation movement and a second finger can control fine navigation movement. The first finger and the second finger can also be used together to generate a sign. For example, the first finger can navigate the cursor over the object of choice, and the second finger can issue a finger sign to perform an action on the object. As another example, the two fingers can be brought closer together to narrow a region of focus (zoom in), or moved farther away from each other to broaded a region of focus (zoom out). The method also includes recognizing when a user is having difficulty signing, and presenting visual notations of signs for conveying finger sign examples to the user. For example, the processor 115 can identify when a user is not issuing a recognizable sign and presents a visual illustration of the signs within an application window. The processor can present finger signs on the display 122 that the user can use to perform an action on an object.

Referring to FIG. 4, the sensing unit 110 is shown in the context of a laptop embodiment. The sensing unit 110 can be integrated within the laptop, or mounted flush with a face of the laptop, for allowing the laptop flip top to close. The sensing element 113 can be exposed between the numeric keys and the function keys on the keyboard 111, just above the function keys of the keyboard 111, on the bottom of a display, or oriented below the display as shown. In general, a user typing at the keyboard 104 can extend and move the finger within a maximum range of finger motion approximated by an ellipse having a volumetric radius under 10 to 12 inches.

As an example, a user can control a movement of the cursor 124. For instance, the user can position the cursor over an object 127, which may be a menu item. The user can perform a finger sign, such as a touchless downward movement, analogous to pressing a button, to select the object 127. The user can also perform a finger sign such as a forward projecting motion for selecting the object 127. Selecting the object 127 is similar to single clicking the object with a mouse when the cursor is over the object 127. The user can also perform a finger sign, such as accelerated right movement, to select a properties dialog of the object 127. In another arrangement, as an example, the user can move the finger in a clockwise motion to zoom in on the object 127, when the cursor 124 is over the object 127. The clockwise motion corresponds to a finger sign. The user can zoom out again, by moving the finger in a counter-clockwise motion, which also corresponds to a finger sign. A finger sign is generally a fixed form, such as a number of fixed clockwise rotations.

Notably, the user can move the cursor 124 to the left and the right in the display 122 in accordance with touchless finger movements. The user can zoom into and out of the page, or into the object 127, using finger signs. In one arrangement, the user can zoom into the page only when the cursor is over an object that supports zooming. For example, if the object is a file hierarchy, a file structure can be opened, or expanded, in accordance with the zoom-in operation. The file structure can also be collapsed in response to zoom-out motions. As another example, the zoom operation can adjust the size of the display relative to the current location of the cursor 124. For example, instead of the object increasing or decreasing in size relative to the other components in the display, the entire display increases or decreases in size thereby leaving sizes of objects in original proportion.

Briefly, the sensing element 113 can be configured for either two-dimensional sensing or three-dimensional sensing. When the sensing element 113 is configured for two-dimensional sensing, the sensing unit 110 may not be able to adequately interpret depth movement, such as movement into or out of the page. Accordingly, finger signing can be used to provide depth control. As previously mentioned, clockwise and counter clockwise finger motion can be performed for zooming into and out of the display, as one example. Moreover, when the sensing unit 110 controls cursor movement based on relative motion, the finger signs can be used anywhere in the touchless sensing space. That is, the finger does not need to be directly over the object 127 to select the menu item or zoom in on the menu item. Notably, with relative sensing, the finger can be away from the object 127, such as to the top, bottom, left, or right of the menu item. The user can position the cursor over the object 127 via relative sensing, without positioning the finger directly over the object 127. The touchless control can be based on relative movement, instead of absolute location. Notably, clockwise and counter clockwise motions are a function of relative displacement, not absolute location. Relative sensing combined with zooming functionality can be useful for searching large amounts of data that are on a display of limited size. For example, a user can navigate into and out of the data using finger signs and touchless finger movements. When the sensing element 113 is configured for three-dimensional sensing, a finger sign, such as a forward projecting or backward can provide zoom functions.

Referring to FIG. 5, a method for touchless interfacing using finger signing is shown. The method 200 can be practiced with more or less than the number of steps shown. Reference will be made to FIG. 1, 2 and 6, when describing the method 200.

At step 202, a touchless finger movement can be sensed. Referring back to FIG. 1, the processor 115 can include a detector, a controller, and a timer to determine when a finger sign is presented. The detector can determine when a finger sign is initiated. For example, during normal typing movement, from the perspective of the sensing unit, the sensing unit identifies incoherent movement. That is, when the user is typing, signals are reflected off the moving fingers causing interference. The detector may not associated incoherent movement with a finger sign. The detector generally associates coherent motion with a sign. For example, when the user signs to the computer, the user ceases typing and raises a single finger which is swept in a slowly and continuous time-varying manner in comparison to normal typing motion where all fingers are moving. The detector identifies coherent motion as an indication by the user that the user is attempting to sign to the computer. The detector also determines a completion of a finger sign when movement has ceased or when non-coherent motion resumes. The timer sets a time window for capturing a sign. For example, during normal typing, the fingers are moving in non-coherent motion. The user stops typing and raises a solitary finger and moves the finger in a pattern. The detector senses the coherent and continuous motion and the timer sets a time window for capturing the sign.

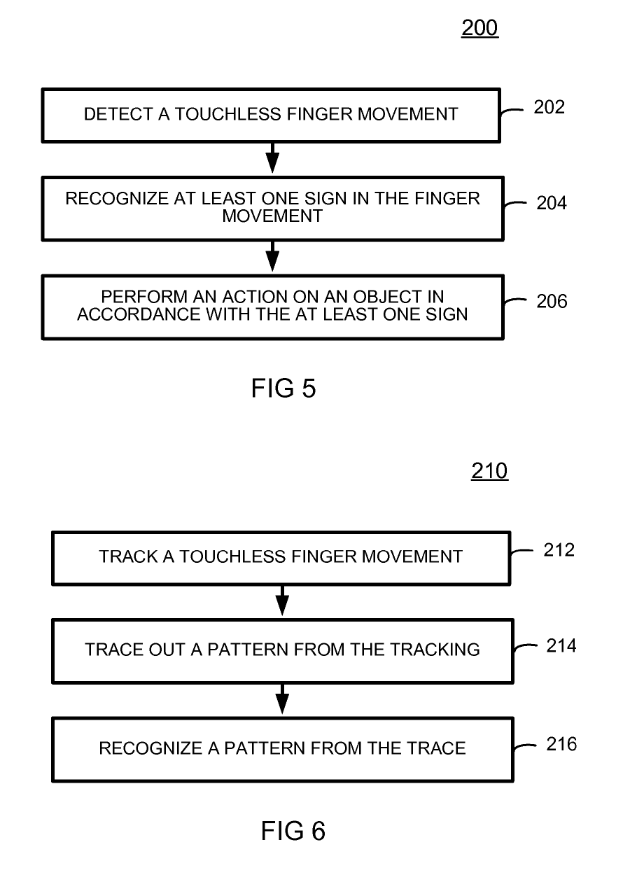

Returning back to FIG. 5, at step 204, at least one sign can be recognized in the finger movement. A finger sign can be a letter, a character, an accelerated movement, or a previously associated pattern. Briefly, referring to FIG. 6, a method 210 for recognizing the finger sign is shown. The method 210 can be practiced by the processor 115 and the pattern recognition unit 114 shown in FIG. 2. At step 201, the processor 115 can track a touchless finger movement. The processor can identify a location and movement of the finger in the touchless sensing space. The processor 115 can save coordinates or relative displacements of the touchless finger movement. At step 214, the processor 115 can trace out a pattern from the tracking. For example, when the tracking is based on absolute locations, the trace can correspond to the finger sign. When the tracking is based on relative displacement, the trace can correspond to changes in finger velocity. At step 216, the processor 115 can provide the trace to the pattern recognition engine 114. The processor 115 may also perform a front end feature extraction on the trace to compress the data. The sensing unit 110 can include a timer which sets a time period for capturing the pattern.

In one arrangement the pattern recognition engine 114 can include a statistical classifier such as a neural network or Hidden Markov Model for identifying the pattern. As previously noted, the sensing unit 110 captures a sign by tracking finger movement, tracing out a pattern resulting from the tracking, and storing the pattern into a memory for reference by the pattern recognition engine 114. The neural network or hidden markov model compares the pattern with previously stored patterns to find a recognition match. The pattern recognition engine 114 can produce a statistical probability associated with the match. The previously stored patterns can be generated through a learning phase. During the learning phase, a user enters finger signs associated with action commands.

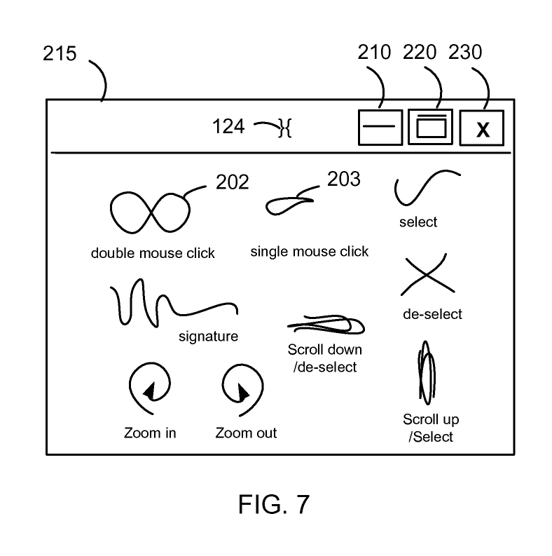

Briefly, referring back to FIG. 1, the pattern recognition engine 114 can recognize finger motion patterns from a vocabulary of signs. Referring to FIG. 7, an exemplary set of finger signs is shown. As one example, a finger sign can be associated with a particular action, such as opening or closing a program window, a zoom operation, a scroll operation, or a hot-key navigation command. Notably, the user can customize a sign language for performing particular actions. As one example, a user can convert a set of hot key combinations to a finger sign. The user can sign to the sensing unit 110 for performing the hot key action without touching the keys.

As the user moves the finger in a sign pattern, the sensing unit 110 traces out a pattern which the pattern recognition engine 114 can identify. If the pattern recognition engine 114 does not recognize the pattern within a time limit set by the timer, an indication can be sent to the user that the sign was not recognized. An indication can be a visual prompt or an audio prompt. The pattern recognition engine 114 can adjust the time window based on the pattern recognized. The pattern recognition engine 114 can produce a measure of confidence, such as an expectation, during the recognition of the finger sign. For example, as the user is signing to the sensing unit, the pattern recognition engine 114 can recognize portions of the pattern as it is being signed, and automatically complete the sign.

Returning back to FIG. 5, at step 206, an action associated with the at least one sign can be performed on an object. An action can be a control of the object, such as an adjustment of a media control, or a selection of the object. For example, an action can correspond to increasing a volume control or adjusting a treble control. An action can also correspond to selecting a menu item from a list. An action can also correspond to entering a text message or dialing a phone number. An action can also correspond to adjusting a view, or zooming into a view. As one example, referring back to FIG. 1, a user can sign numbers of a telephone number in the touchless sensing space 101. The sensing unit 110 can recognize the numbers and enter the recognized numbers in a phone dialing application. The action is the entering of the recognized number in the application. As another example, a user can create a text message letter by letter through touchless signing of individual letters in the touchless sensing space 101. As another example, a user signs to the computer 125, which speaks out a recognized letter, word, phrase, or sentence such as a learning system for children within a computer game. As another example, a user signs to the computer 125, which responds by playing an audio clip or video clip associated with the sign. For example, a finger sign may be an indication to play the next song, or revert to the previous song.

Referring to FIG. 7, a finger sign can be a finger movement gesture, or a combinational movement gesture of a first finger and a second finger. As illustrated, a finger sign can be a circular pattern, a portion of a figure eight pattern, a jitter motion (e.g. shaking of a finger), a sweep (e.g. controlled movement of the finger from one location to another location), a jiggle, a forward projecting motion, a retracting motion, an accelerated sweep, a constant velocity motion, or a finger movement, but is not limited to these. The pattern can be produced by at least one finger. The signs can each have an associated action such as a single mouse click, a double mouse click, a scroll behavior, a move vertical behavior or move down behavior. The pattern recognition engine 114 can also recognize multiple signs in sequence. The sensing unit 110 can include a display element, such as a led, to indicate the completion of a sign capture, or an audio response to indicate sign capture. As one example, a user can motion a finger sign for minimizing a window 210, maximizing a window 220, or closing a window 230 within the program application 215. The cursor 124 is not required to be over the minimize button 210 to minimize the window 210. For example, the user can be typing within a word processing application and minimize the word processing application by issuing a finger sign. The signs 202, 203, and such illustrated in the display 122 are presented for illustration. The user may or may not see the outline of a finger sign.

Referring back to FIG. 3, a user can position two hands above a keyboard 111 for controlling a cursor object 124 within a display 122. A first finger 186 on the left hand and a second finger 188 on the right hand can control the cursor object 124 within a display 122. The user can move the first and second finger for signing motion to the computer to control a cursor object. The user signs to the sensing unit using a finger sign such as those shown in the windows application 215 of FIG. 7. A single finger can be used to generate a sign, or two fingers can be used to generate a sign. For example, the user signs a figure eight pattern 202 using a single finger to invoke an action on the cursor object 124. The action can correspond to a mouse behavior such as a single click, a double click, a scroll, a left click, a middle click, a right click, or a hold operation. For example, the user navigates the cursor via finger movement to position the cursor 124 over a windows action toolbar, containing elements such as a minimize 210, a maximize 220, or a close 230. The user then signs a pattern associated with one of the toolbar elements for performing an action. For example, the user signs a circle pattern for minimizing the window 215, or a jitter motion for minimizing the window 215, or a jitter sweep for closing the window 215. Other finger signs are contemplated within the scope of the invention. The finger signs shown in the windows application 215 are presented merely for illustrating the finger motion involved with creating the finger sign.

In another aspect, the action includes activating one of a web based transaction, an email transaction, an internet transaction, an on-line purchase order, a sale, a notarization, an acknowledgement, playing an audio clip, adjusting a volume, controlling a media engine, controlling a video engine, and controlling a text engine, and controlling and audio engine. The action also provides a cut-and-paste operation, a text highlight operation, a drag-and-drop operation, a shortcut operation, a file open operation, a file close operation, a toolbar operation, a palette selection, a paint operation, a custom key shortcut operation, or a menu selection operation corresponding to a menu entry item in a windows application program.

As another example, the pattern recognition engine 114 can recognize a finger sign as an electronic signature, or notarization, for conducting a transaction or a sale. Moreover the pattern recognition engine 114 can apply biometric analysis to validate or authenticate the finger sign. As another example, a user can access a web page requesting an electronic signature, and the user can sign to the computer for inputting the electronic signature. As another example, the user can include a personal signature on an email message by finger signing. In yet another aspect, the finger sign corresponds to a password for identifying a user. For example, a user enters a website requiring an authentication. The user initiates a finger sign that the website recognizes as belonging to the particular user. The finger sign serves as an identification stamp, much as a finger print serves as user identification.

In one embodiment, the sensors 113 can comprise ultrasonic transducers. For example, the sensors 113 can include at least one transmitter and at least one receiver for transmitting and receiving ultrasonic signals. The sensor unit 110 can track touchless finger movements using time of flight measurements and differential time of flight measurements of ultrasonic signals. The transmitter and emitter can be the same transducer for providing dual transmit and receive functions. In another arrangement, the sensing element can be an array of micro acoustic microphones or micro speakers for transmitting and receiving audio signals. In another arrangement, the sensing element can be CCD camera elements, analog integrated circuits, laser elements, infrared elements, or MEMS camera elements for receiving light.

The sensing unit 110 can employ pulse-echo detection to estimate a range and position of the touchless finger movement within the touchless sensing space 101. A transmitter in the sensing unit can emit a pulse shaped signal that produces multiple reflections off the finger. The reflections can be detected by multiple receiver elements. Each receiver element can receive a reflection signal. The processor 115 can estimate a time of flight (TOF) and a differential TOF (dTOF) from each reflection signal for each receiver. The processor 115 can include additional processing logic such as thresholds, comparators, logic gates, clocks, and the like for detecting a time of arrival of the reflection signal. The time of arrival establishes the TOF. The sensing unit 110 calculates a position of the object based on the TOFs and the dTOFs. In particular, the processor 116 can identify the location of the finger by solving for the intersection of a series of quadratic equations that are a function of the TOF. Moreover, the processor 116 can supplement the location of the finger with dTOF measurements to refine the precision of the location.

The sensing unit 110 can produce a coordinate for every transmitted pulse. As the finger moves within the touchless sensing space 101, the sensing unit 110 keeps track of the finger locations. The sensing unit 110 can connect absolute locations, or differential locations, to create a trace. The sensing unit 110 can use one of linear interpolation or polynomial approximations to connect a discrete location (x₁,y₁) with a second discrete location (x₂,y₂) of the trace. The tracking of the finger movement results in the generation of a trace which is stored in memory and can be identified by the pattern recognition engine 114.

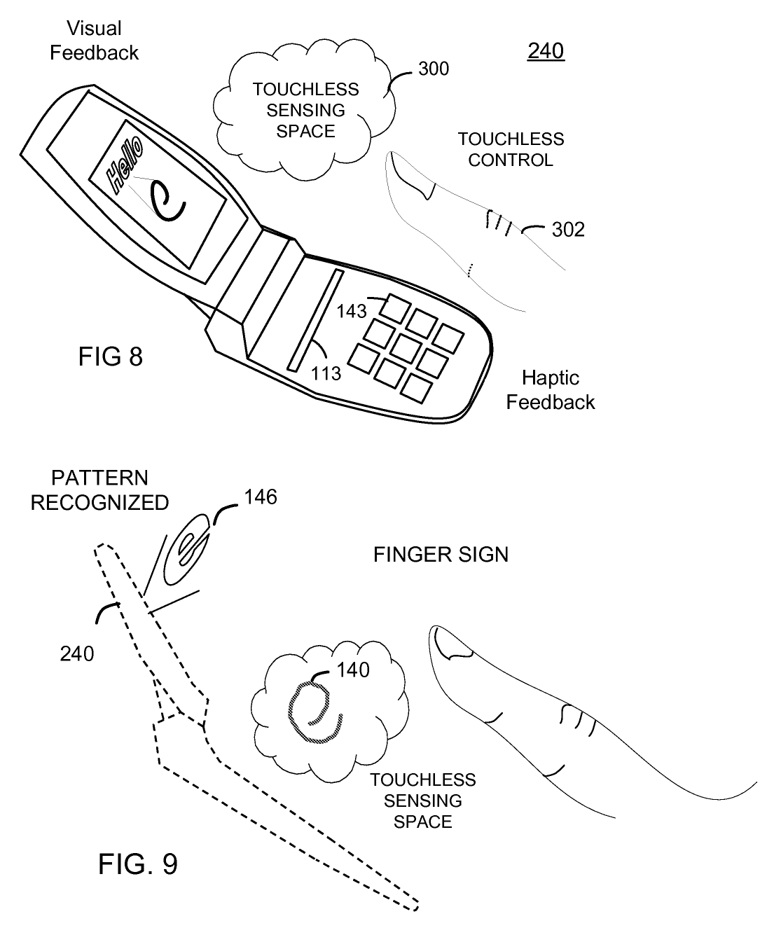

Referring to FIG. 8, another exemplary use of touchless interfacing using finger signing is presented. As shown, the sensing unit 110 can be integrated with a mobile device 240. Only the sensor element 113 is shown. The remaining components of the sensing unit 110 can be integrated within the mobile device, or as an accessory attachment. In one arrangement, the sensor element 113 can be placed above a keypad 143 of the mobile device 240. The sensing unit 110 can create the touchless sensing space 101 over the keypad 143 and in front of the display. The touchless sensing space 101 is not limited to the arrangement shown. For example, the touchless sensing space 101 can be above the keypad, above the display, or above another portion of the mobile device 240. The touchless sensing space 101 provides a virtual user interface for operating the mobile device. A user can position a finger 302 or a thumb within the touchless sensing space 108 and perform a finger sign to handle one of more controls of the mobile device, such as a menu item 226. As one example, a user can navigate a menu structure of the mobile device by issuing touchless finger commands. For example, a user can perform a left-right jitter movement on a left side to access a left menu, or a left-right jitter movement on a right side to access a right menu. As another example, the user can scroll through a contact list by issuing up-down finger movements. The user can reverse scrolling direction by issuing a broad left-right finger sweep motion. Notably, the sensing unit 110 and the associated components can be integrated within the mobile device 240.

As shown in FIG. 9, a user can position a finger 302 within the touchless sensing space 101 to interface with the mobile device 100. The touchless sensing space 101 is separate from any surface of the mobile device, display, or keypad. That is, the touchless sensing space 101 is not touch based like a touch screen or a touchpad. Moreover, the touchless sensing space 101 is projected away from the display of the mobile device 240. This can provide the user an unobstructed view of the display when performing touchless finger signs in the touchless sensing space 101. That is, the fingers will not be in front of the display blocking view of the graphics or images in the display. From a user viewing perspective, the finger will not interference with the visual elements on the display.

The user can motion a finger sign or a finger gesture in the touchless sensing space 101 for acquiring and handling a control of the mobile device. In one aspect, the sensing device 100 and sensing field 101 can perform touchless character recognition of finger signs. For example, a user can move the finger in the touchless sensing space 101 and draw out an alpha-numeric character 140. The sensing device 110 can recognize the alpha-numeric character from the finger movement, and present a pattern 146 corresponding to the finger sign 140. For example, a user can finger sign the letter ‘e’ 140 and the sensing unit 110 can recognize and present the text pattern ‘e’ on the display. The sensor device 100 can enter the pattern into an application such as a notepad application, an email message, a dictation application, a phone number dialing application, or any other application which can process alpha-numeric character information, such as letters, characters, of symbols.

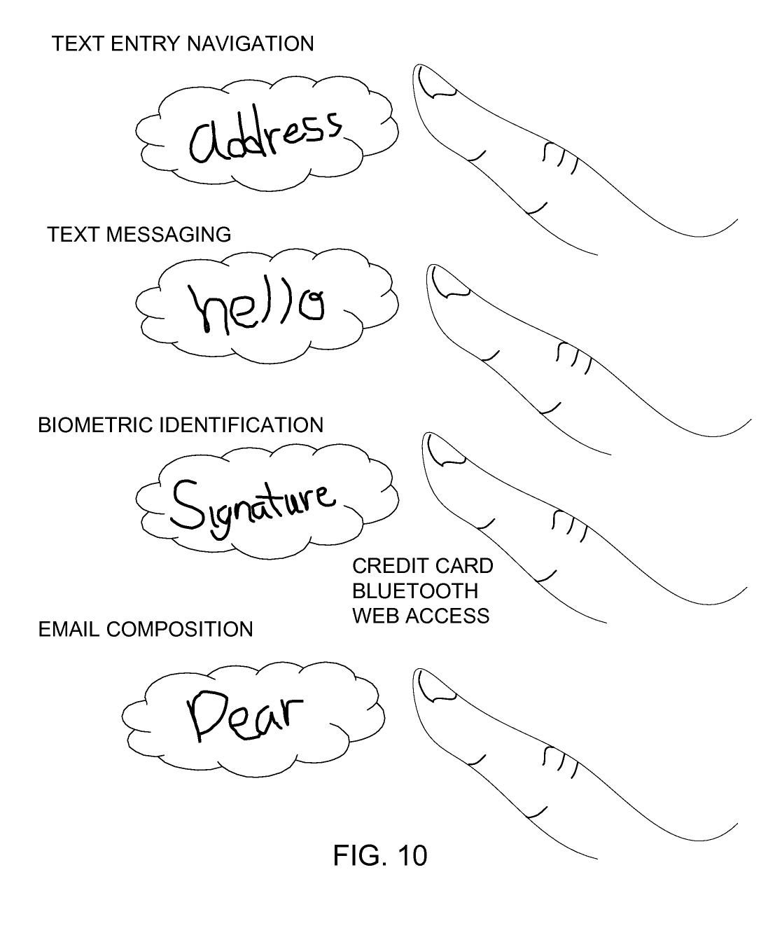

Referring to FIG. 10, exemplary uses of touchless signing are shown. As one example, touchless signing can be used to enter an address into a navigation system or application. As another example, touchless signing can be used for text messaging. A user can enter a sequence of finger signs to spell out a word. In another arrangement, finger gestures associated with complete words can be entered. As another example, touchless signing can be used for biometric identification. A finger signature can be validated to authorize access to a service. For example, the sensor device 110 may be on a kiosk or a credit card payment terminal. Instead of authorizing a transaction via touchpad or touch screen signing, a user can perform touchless signing. Moreover, a recognition engine can identify a touchless writing style of the user to verify an identity of the user. That is, in addition to recognizing finger signs, such as characters, the sensing device 110 can verify an identity of a user based on the user's finger signing style. The verification can be in combination with another form of presented identity, such as a credit card pin number, or a biometric voice print. The biometric identification can also be for accessing a web site or a service on a cell phone.

For example, a user of a cell phone desiring to perform a wireless transaction may require a proof of identify. The user can perform a finger signature as validation. It should also be noted, that the user may perform touchless signing letter by letter at the same point in the touchless sensing space 101. In touchless finger signing, the letters can actually overlap as the user repositions the finger to a center position in the touchless sensing space for the creation of each letter in the signature. In another aspect, the biometric identification can be evaluated in combination with a credit card. For example, a mobile device may include a credit card sweeper, and the user can sign a transaction for the credit card via touchless finger signing. As another example, touchless signing can be used for composing emails. In such regard, a user can compose a text message letter by letter via touchless finger movements. In another aspect, finger gestures can represent words. In such regard, a user can compose a text message word by word via finger gestures. In another aspect, the finger gestures can perform control actions on the phone, such as automatically performing a hot-key operation to access a menu control.

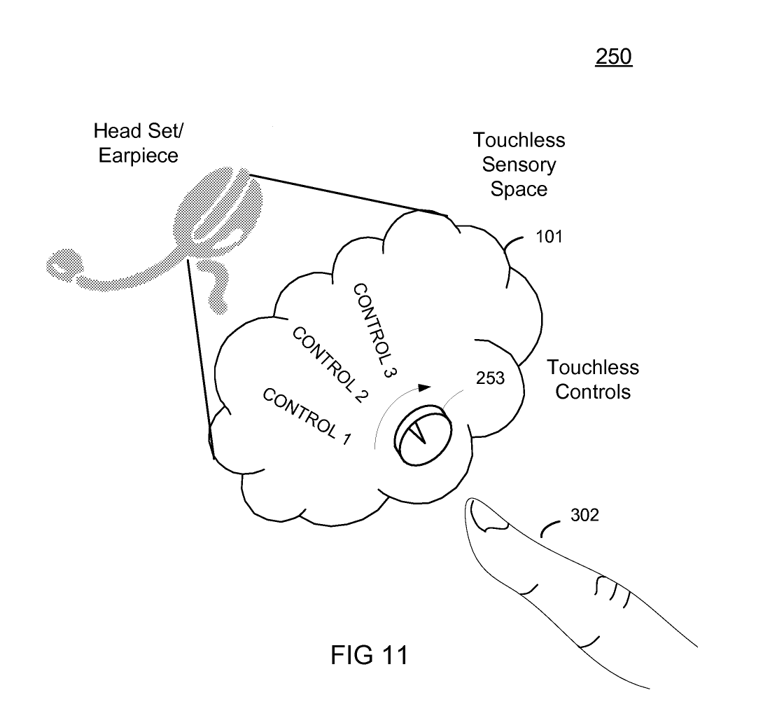

Referring to FIG. 11, another exemplary use of touchless interfacing using finger signing is presented. In particular, the sensing unit 110 can be integrated within a headset 250, such as a Bluetooth mobile device headset. The sensing unit 110 can project a touchless sensing space 101 that allows a user to adjust a control 253 of the headset 250 via touchless finger signs. As one example, the user can perform a finger sign to select a control. For example, the user can perform a clockwise finger sign to scroll to different controls. The user can perform a counter clockwise finger sign to scroll back to previous controls. As an example, the user can issue an up-down finger sign to select an entry, or a left-right finger sign to cancel, or return to, a previous selection. In one arrangement, the headset earpiece 250 can present an audible sound as each control, is selected, or as an adjustment is made to a control. For example, the user may move the finger 302 in a clockwise circular motion to scroll through a virtual selection list of songs, emails, or voice messages. As the user moves the finger through a signing motion, the earpiece can play an audible indication corresponding to the current virtual selection. For example, a sound clip of a song can be played when the finger is at an absolute or relative location corresponding to the song. In another arrangement, the indicator can be a vibration element in the headset that vibrates in accordance with the location and movement of the finger 302.

As another example, the sensing unit 110 can be included within an automobile for adjusting audio controls such as volume, selection of a radio station, or selection of a song, but is not limited to these. As another example, the sensing unit 110 can be included within a medical system for converting a physical command such as a hand motion to a particular action on an object when a user cannot physically interact with the system. As another example, the sensing unit 110 can be used to produce a touchless reply in a text messaging environment. As another example, the sensing unit 110 can capture a profile, an outline, or a contour of an object, by using hand or finger gestures to describe the attributes of the object for purposes of graphic design, art, or expression.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A sign engine for controlling an object via touchless sensing comprising
a sensing unit that detects at least one touchless finger sign;
a pattern recognition engine operatively connected to the sensing unit that identifies at least one pattern in the touchless finger sign; and
a processor operatively coupled to the pattern recognition engine that performs an action on the object in accordance with the at least one pattern.

2. The sign engine of claim 1, wherein the processor visually presents the at least one pattern.

3. The sign engine of claim 1, wherein the processor audibly presents the at least one pattern.

4. The sign engine of claim 1, further comprising:
a voice recognition unit that captures a spoken utterance from a user and determines whether the at least one finger sign was correctly recognized in response to the spoken utterance.

5. The sign engine of claim 1, wherein the pattern recognition engine recognizes and authenticates a finger signature for a secure application.

6. The sign engine of claim 1, wherein the pattern recognition engine automatically completes a finger sign that is partially recognized.

7. A method for touchless interfacing using signing, the method comprising
detecting a touchless finger movement in a touchless sensing space;
identifying a finger sign from the touchless finger movement; and
performing a control action on an object in accordance with the finger sign.

8. The method of claim 7, further comprising recognizing an alpha-numeric character, and providing the alpha-numeric character to an application.

9. The method of claim 7, wherein the step of performing a control action includes issuing a single click, a double click, a scroll, a left click, a middle click, a right click, or a hold of the object.

10. The method of claim 7, wherein the step of performing a control action includes adjusting a value of the object, selecting the object, moving the object, or releasing the object.

11. The method of claim 7, wherein the step of performing a control action includes performing a hot-key combination in response to recognizing a finger sign.

12. The method of claim 7, wherein the step of performing a control action includes expanding a view in response to a clockwise finger motion, and collapsing the view in response to a counter-clockwise finger motion.

13. The method of claim 7, wherein the object is an audio control, a video control, a voice control, a media control, or a text control.

14. The method of claim 9, wherein the step of performing a control action performs a cut-and-paste operation, a text highlight operation, a drag-and-drop operation, a shortcut operation, a file open operation, a file close operation, a toolbar operation, a palette selection, a paint operation, a custom key shortcut operation, or a menu selection operation corresponding to a menu entry item in a windows application program.

15. The method of claim 7, wherein a finger sign is a letter, a number, a circular pattern, a jitter motion, a sweep motion, a jitter motion, a forward projecting motion, a retracting motion, an accelerated sweep, or a constant velocity motion.

16. A method for touchless text entry via finger signing, comprising:
tracking a touchless finger movement in a touchless sensing space;
tracing out a pattern in accordance with the tracking; and
recognizing an alpha-numeric character from the pattern, wherein the pattern is a letter, a number, a symbol, or a word.

17. The method of claim 16, further comprising:
presenting the alphanumeric character to a text messaging application or a phone dialing application.

18. The method of claim 16, further comprising recognizing a finger signature and authenticating the finger signature.

19. The method of claim 16, wherein the finger signature is a password that identifies a user.

20. The method of claim 16, further comprising:
recognizing when a user is having difficulty finger signing; and
presenting visual notations of finger signs for conveying finger sign examples to the user.
